(19) United States
(12) Patent Application Publication
(10) Pub. No.: US 2007/0233832 A1
(43) Pub. Date: Oct. 4, 2007

(54) Method of distributed hash table node ID collision detection

(75) Inventors: Sathya Narayanan, Plainsboro, NJ (US); Eunsoo Shim, West Windsor, NJ (US); David A. Braun, Danville, NJ (US)

Correspondence Address: RATNERPRESTIA, P.O. BOX 980, VALLEY FORGE, PA, 19482, US

(73) Assignee: Matsushita Electric Industrial Co., Ltd.

(21) Appl. No.: 11/393,463

(22) Filed: Mar. 30, 2006

(51) Int. Cl. G06F 15/173

(52) U.S. Cl. 709/223

(57) ABSTRACT

A method for joining a network resource as a joining node to a peer-to-peer network includes establishing a node ID for the joining node to be joined to the peer-to-peer network, routing the join message to an assignment node that manages resources with resource IDs closest to the node ID of the joining node, determining whether or not the node ID established is identical to respective ones of the node IDs on the peer-to-peer network, and joining the joining node to the peer-to-peer network, when the node ID of the joining node is not identical to any one of the node IDs on the peer-to-peer network.

### FIELD OF THE INVENTION

The present invention relates to the field of distributed networks generally and, in particular, a method of distributed hash table node ID collision detection in peer-to-peer networks.

### BACKGROUND OF THE INVENTION

Peer-to-peer networks have become increasingly popular with their primary application being file-sharing. Others are using P2P networks for communication, such as Skype® which has implemented a voice over Internet protocol (VoIP) P2P telephone service.

Distributed hash tables (DHTs) are used in certain peer-to-peer networks to improve efficiency of locating resources on these networks. In these networks, a hash key (resource ID) is associated with a resource (e.g., a file) and each node in the system is responsible for storing a certain range of hash keys of a hash space. A lookup for a particular key is routed through the network to the node responsible for the key using a specific routing algorithm. Resources may be stored in a hash table corresponding to their resource ID. Node Identifiers (Nodes IDs) are assigned to each node in the network and are mapped to the same hash space as the resource IDs. Typically, in a DHT resources are assigned to a node having a node identifier (Node ID) that is closest, according to some location determination, to the resource ID. Details of the methods used to determine the location of the identifiers depend on the particular DHT mechanism being used. That is, each node is responsible for storing all resources that have a certain range of resource IDs. Nodes may exchange messages in response to a node joining or leaving to maintain the DHTs.

An exemplary Distributed Hash Table (DHT) is defined in an article by I. Stoica et al. entitled, “Chord: A Scalable Peer-To-Peer Lookup Service for Internet Applications,” in ACM SIGCOMM'01, August 2001. A large scale Chord network may be built using a huge hash key space such as a set of 128 bit integers and a cryptographic hash function such as the SHA-1 function, defined in a standard entitled “Secure Hash Standard,” NIST, FIPS PUB 180-1, April 1995.

FIG. 1 (Prior Art) is a diagram of a network using a Chord topology.

Referring now to FIG. 1, exemplary Chord P2P network 100 includes nodes 0-15 and resources (not shown) assigned identifiers from an identifier space. Network 100 may include a plurality of physical nodes, 120, 130 and 140, a plurality of processors 160, 170 and 180 which corn with each other via physical nodes 120, 130 and 140 and a physical network 110. Physical network 110 may include any number of physical nodes and corresponding processors. Each processor 160, 170 and 180 may include a part of the DHT and may be uniquely identified by physical network 110. Each processor 160, 170 and 180 may include other connected resources (not shown) and each processor 160, 170 and 180 and the other connected resources may vary in the size (i.e. storage capacity and processor power) and the bandwidth of the connection to the network 100.

In the example illustrated, the number of bits assigned to each identifier is 4 and, thus, the identifier space is 0-15. The number of bits, however, may be any number and may be denoted as m. Thus the identifier space may consist of numbers from 0 to 2^{m}−1. Modulo 2^{m} is used for numeric operations and thus the identifier space may be ordered in a circular fashion, forming an identifier circle, called a Chord ring. A resource ID is a hash key generated from the name of the resource. As described above, it may be desirable to use a cryptographic hash function such as SHA-1.

IP addresses of nodes joining the Chord ring 100 may not be unique. That is, as examples, IP addresses for devices from the same network connected though a gateway may be identical. In such a situation, collisions between nodes may occur when the IP address is stored as the node ID.

A resource with key k may be assigned to the first node having a node ID that is equal to or follows k in the Chord ring. Such a node is called the successor of key k, denoted by successor(k). Successor(k) is the first node clockwise from k in the Chord ring 100. Predecessor(k) is the first node counter-clockwise from k in the Chord ring 100. With respect to a particular node, for example with node ID 8, the next node in the Chord ring 100 (e.g., as illustrated as the node which is the next in a clockwise orientation) is called its successor (i.e., the node with node ID 12) and the previous node (the node counter clockwise) in the Chord ring 100 is its predecessor (i.e., the node with node ID 0).

Each node tracks, in a finger table, m other nodes called fingers that are the successors of keys n+2ⁱ⁻¹ for each i=1, . . . , m. For any particular node, the nodes identified in its finger table are neighboring nodes, since these nodes are reachable in one hop. Further, a particular node may keep track of its predecessor node. Each node has many entries pointing to nearby nodes, and fewer entries pointing to more remote nodes. These finger tables are populated when a respective node joins the Chord ring 100, and are maintained via communication between various nodes during the operation of Chord ring 100.

A resource with resource ID k is stored by successor(k). As nodes enter or leave, resources may be stored on different nodes. Thus, information related to the nodes is exchanged as nodes join and leave the network. If a node failure occurs, redundant information maintained in successor and predecessor nodes of the first node may be used to maintain the Chord ring 100.

Communications may be routed based on a characteristic of the finger tables, namely that nodes have more information about nodes (node IDs) closer to their identifer space than those further away. When locating a resource with a particular resource ID, a lookup operation may be used. The node initiating the operation (e.g., a first node) may forward a query to a node from its finger table (e.g., a second node) that is either successor(resource ID) or a node with the largest node ID that is smaller (modulo 2^{m}) than k. This process may be repeated, if necessary, from node to node until successor(k) is reached. A finger of node n is successor(k) if the finger is the successor of n+2ⁱ⁻¹ for i such that key k is equal to or greater than n+2ⁱ⁻¹ and the finger's Node ID is equal to or greater than key k. That is, if, for a certain i=1 . . . m, n+2ⁱ⁻¹≦k≦successor (n+2ⁱ⁻¹), then successor(n+2ⁱ⁻¹) is also successor(k). During the forwarding steps, the query may reach predecessor(k). The successor of predecessor(k) is successor(k), and thus predecessor(k) forwards the query to successor(k). A node knows it is successor(k) if its predecessor's Node ID is smaller than key k (modulo 2^{m}). Upon receiving the query, successor(k) replies to the query originator (the first node) with the requested information corresponding to the key if it has the information requested in the query. Otherwise, successor(k) replies to the query originator with a lookup failure message. In a Chord ring that has N nodes, the query reaches successor(k), on average after being forwarded log(N) times. That is, if the Chord ring has 64,000 nodes, any query for resource k takes, on average, 16 hops to reach successor(k). This characteristic is the same for many known DHTs such as Chord, Pastry, and Tapestry.

Typical query messages contain the target resource name or identifier and a Time-to-Live (TTL) value. Intermediate nodes forwarding the query messages may decrement the TTL value.

To facilitate proper operation of the Chord ring 100, each node maintains its finger table and as a node joins or leaves the Chord ring 100, chord finger tables throughout the Chord ring 100 are automatically updated accordingly.

In the exemplary system, when a joining node requests to join the network, the joining node applies the hash function of the DHT to its IP address to generate an indentification value.

### SUMMARY OF THE INVENTION

The present invention is embodied in a method for joining a network resource as a node to a peer-to-peer network. The method includes establishing a node ID for the joining node in the peer-to-peer network and routing the join message to an assignment node that manages resources with resource IDs closest to the established node ID. The joining node determines whether or not the established node ID is identical to respective ones of the node IDs on the peer-to-peer network. When the node ID of the joining node is not identical to any one of the node IDs on the peer-to-peer network, the joining node joins the network.

The present invention may also be embodied in a method for joining a network resource as a node to a peer-to-peer network. The method includes establishing a node ID for the joining node based on one or more components related to the joining node and one or more components independent of the joining node. The join message is routed to an assignment node that manages resources with resource IDs closest to a node ID of the joining node. The joining node joins the peer-to-peer network.

The present invention may also be embodied in a method for joining a network resource as a node to a peer-to-peer network. The method establishes a node ID for the joining node based on one or more components which are related to the joining node and one or more components which are independent of the joining node. A message including the node ID from the joining node is sent to one or more other nodes and routed the join message to an assignment node that manages resources with resource IDs closest to the established node ID. The method determines whether or not the established node ID is identical to a respective one of node IDs of nodes on the peer-to-peer network, and joins the joining node to the peer-to-peer networks, when the node ID of the joining node is not identical to any of the resource IDs managed by the assignment node.

### BRIEF DESCRIPTION OF THE DRAWINGS

The invention is best understood from the following detailed description when read in connection with the accompanying drawings. It is emphasized that, according to common practice, various features/elements of the drawings may not be drawn to scale. Moreover in the drawings, common numerical references are used to represent like features/elements. Included in the drawing are the following figures:

FIG. 1 (Prior Art) is a diagram of a peer-to peer network used in accordance with exemplary embodiments of the present invention;

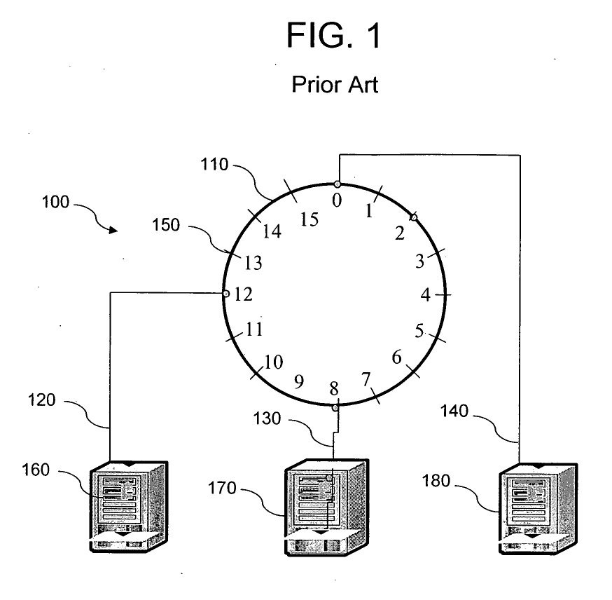

FIG. 2 is a flow chart illustrating a method of collision detection for a node ID in accordance with an exemplary embodiment of the present invention;

FIG. 3 is a flow chart illustrating a method of collision detection for a node ID in accordance with another exemplary embodiment of the present invention; and

FIG. 4 is a flow chart illustrating a method of collision detection for a node ID in accordance with yet another exemplary embodiment of the present invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Problems can occur in networks which use IP addresses as node IDs because such node IDs may not be unique and thus node ID collisions may occur causing both degradation in system performance and system errors.

It is contemplated that certain exemplary embodiments of the present invention may include node ID collision detection to reduce and/or eliminate the possible that node IDs may be identical.

It is further contemplated that certain exemplary embodiments of the present invention may include a random identifier (number or string) with which at least the IP address is hashed. Since the IP address in many cases relates to the node, it can provide valuable information. By including a random bit stream with the IP address, it is possible to reduce or substantially eliminate the possibility that node IDs obtained after applying the hash function may be identical. That is, in such a network, by adapting a node ID which includes a device related component and a random component security of the network may be enhanced while reducing the chance of collision between nodes. Moreover, by checking whether the node ID of a joining node already exists on the network prior to the join being completed it is possible to avoid collisions of nodes.

Although certain exemplary embodiments are described in terms of either the use of: (1) collision node ID detection; or (2) a random identifier with the IP address, they may also include combinations thereof.

Although certain exemplary embodiments are described in terms of a Chord or a peer-to-peer network, they may be applied to other networks employing DHT's to reduce or substantially eliminate node ID collisions on the network. For example, they may apply to other P2P networks including CAN networks, Pastry networks, and Tapestry networks, among others. Moreover, the term finger table may be generalized in such networks to routing table and the terms successor and predecessor nodes may be generalized in such networks to refer to: (1) nodes that neighbor a particular node (in proximity to the particular node based on the structure of the identification space); (2) nodes that are in the routing table of the particular node or (3) nodes that are known to the particular node.

It should be understood that the methods illustrated may be implemented in hardware, software, or a combination thereof. In such embodiments, the various components and steps described below may be implemented in hardware and/or software.

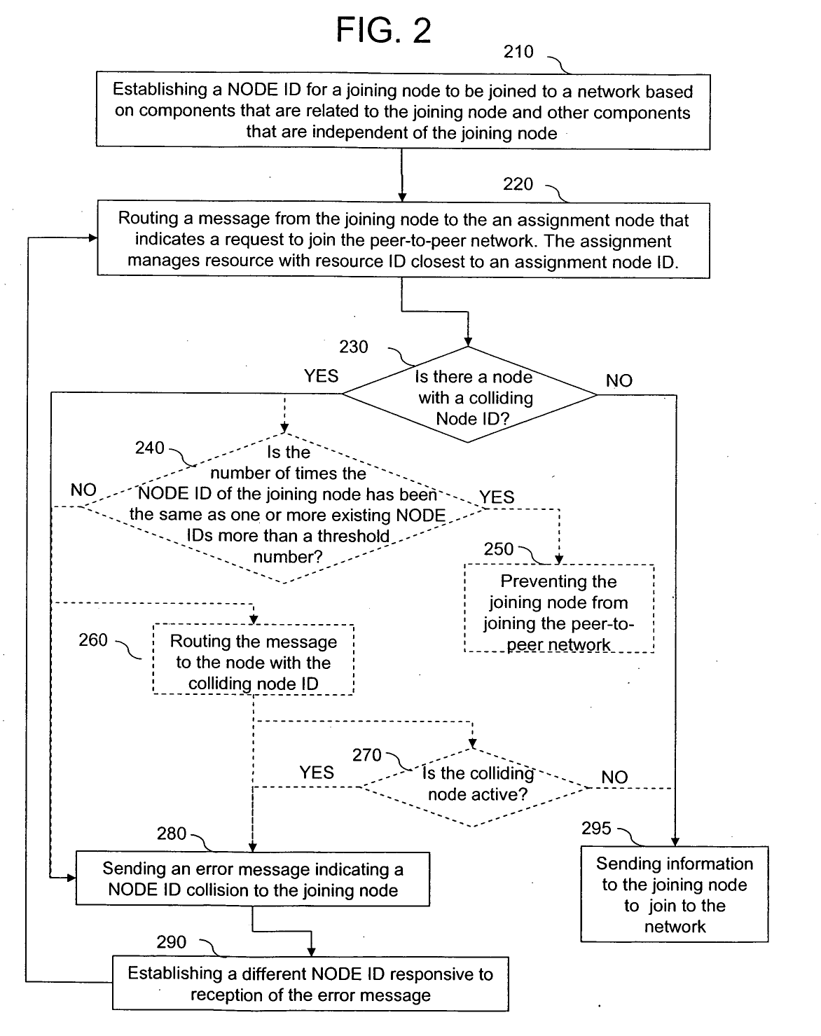

FIG. 2 is a flow chart illustrating a method of collision detection for a node ID in accordance with an exemplary embodiment of the present invention.

Referring now to FIG. 2, at block 210, a node to be joined to network 100 (e.g., a peer-to-peer network or some other distributed network) may establish a node ID, based on components that are related to the joining node and other components that are independent of the joining node. For example, the components which are related to the joining node may include an IP address of the joining node and/or a port number of the joining node and the components which are independent of the joining node may include a random bit stream. In certain exemplary embodiments, the establishment of the node ID may include applying a hash function to a value that is a combination of an IP address of the joining node, a port number of the joining node and a random bit stream, and may include concatenation of these components or some other algebraic combination of these components for further security of the IP address and port number of the joining node. The random bit stream may be of sufficient length based on an overall number of node IDs on the peer-to-peer network to ensure a unique node ID with a predetermined probability or greater. In certain exemplary embodiments the predetermined probability is 99% or greater.

At block 220, a message may be routed to the assignment node that manages resources with resource IDs closest to the node ID of the joining node (e.g., the assignment node succeeding the resource ID of the joining node). The routing of the message from the joining node to the assignment node may include one or more intermediate node hops (i.e., communications). That is, since the joining node does not have information (the node ID) of the assignment node, the joining node may send a message (e.g., request), for example, to a bootstrap node (e.g., an intermediate node). This message may either be forward to the assignment node (either directly or through intermediate nodes) or information regarding the node ID of the assignment node may be sent to the joining node and the joining node may then route the message to the assignment node.

Although a search for the assignment node is described using a bootstrap node, it is contemplated that other searches are possible. For example, a broadcast message may be sent by the joining node requesting a response by the assignment node.

At block 230, a determination whether or not the node ID established at block 210 is identical to respective ones of the node IDs on peer-to-peer network 100 is performed. The determination may include the processor at the assignment node comparing the node IDs of resources controlled by the assignment node to the node ID of the joining node.

In certain exemplary embodiments, at block 240, if the node ID of the joining node matches one of the node IDs of nodes on peer-to-peer network 100 (i.e., if there has been a collision), the number of times error messages indicating node ID collisions have been received by the joining node is determined. At block 250, if this number is greater than a predetermined threshold number (i.e., excessive error messages are indicated), the joining node may be prevented from joining the peer-to-peer network, for example, by rejecting messages that request joining of any node with the same IP address and/or port number as that of the joining node determined to have excessive error messages. This rejection of subsequent messages may be for an indefinite or a predetermined period of time. That is, by implementing such a process, for example, intentional attacks based on node ID collisions may be substantially reduced based on the use of the IP address and/or the port number of the joining node.

In certain exemplary embodiments, at block 260, if the node ID of the joining node matches one of the node IDs of nodes on peer-to-peer network 100, a message may be routed to the colliding node (i.e., the node with the node ID that is identical to that of the joining node) to verify that the colliding node is active on the peer to peer network. Block 270 determines whether the colliding node is active. It is possible, for example, that the assignment node may indicate a particular node ID collision exists but the actual node that is indicated to be in collision has left peer-to-peer network 100. That is, the assignment node may not have been informed that the colliding node has left peer-to-peer network 100 or may not be timely informed that such a node has left peer-to-peer network 100, for example, due to timing of messages in the network 100. In many instances, however, the assignment node is the colliding node.

The determination of whether a colliding node is active may include the routing of a message from the assignment node to the colliding node such that a response by the colliding node indicates activity of the colliding node. By checking with the colliding node, improved node ID collision detection may be realized. If the colliding node is active on the peer-to-peer network, the colliding node may receive the message from the assignment node and may either respond with an error message directly to the joining node or, otherwise, may send an error message back to the assignment node which then may forward the error message back to the joining node. The error message may indicate a node ID collision. If the colliding node is not active (e.g., has left peer-to-peer network 100), a time-out occurs due to a lack of a response from the colliding node. In this case, the assignment node may send joining information to the joining node or may retransmit the message to the colliding node. After a specified number of retransmissions (include possibly no retransmissions), the joining information may be sent to the joining node.

In certain exemplary embodiments, at block 280, the response by the colliding node may include sending an error message to the joining node indicating a node ID collision. In other exemplary embodiments, the error message may be sent from the assignment node to the joining node with or without the step in block 270 of determining whether the colliding node is active.

At block 290, the joining node may generate a different node ID responsive to reception of the error message. Generating the different node ID for the joining node may include generating a new random bit stream and combining and/or concatenating the new random bit stream with the IP address and/or port number of the joining node. The processing from block 290 returns to block 210. That is, responsive to reception of the error message, the different node ID may be established for the joining node.

At block 295, if the node ID of the joining node does not match any node IDs on peer-to-peer network 100 or if the colliding node is not active, joining information may be sent to the joining node to enable the joining node to join the peer-to-peer network 100. That is, this joining information may be sent from the assignment node to the joining node: (1) if the node ID of the joining node does not match any node IDs of nodes on peer-to-peer network 100 at block 230 or (2) if it matches but the colliding node is not active. In certain exemplary embodiments, the joining information may include the predecessor node and successor node of the joining node. After receiving the joining information about the predecessor and successor nodes of the joining node, the joining node may send and receive further messages from the successor and predecessor nodes to complete the joining process.

It is contemplated that the messages routed to the assignment node and/or the colliding node may be either a join message or a lookup message. In certain exemplary embodiments, a join message may be routed by the joining node, and when a node ID collision is indicated, an error message relating to the join message may be routed to the joining node. In other exemplary embodiments, a lookup message may be routed by the joining node, and when a node ID collision is indicated, a lookup success message relating to the lookup message may be routed to the joining node. Upon receiving this message, the joining node would know that its node ID was already taken and select a new node ID to lookup. The join message may include: (1) the joining node information (e.g., an IP address and/or a port number); (2) proxy node information (IP address/port) for network access traversal (NAT); and (3) the joining node ID. The lookup message may include (1) the joining node information (e.g., the IP address and/or the port number); (2) the proxy node information (IP address/port) (for network access traversal); (3) the joining node ID; (4) a target resource ID that is equal to the joining node ID and (5) a resource type that is equal to “node information”.

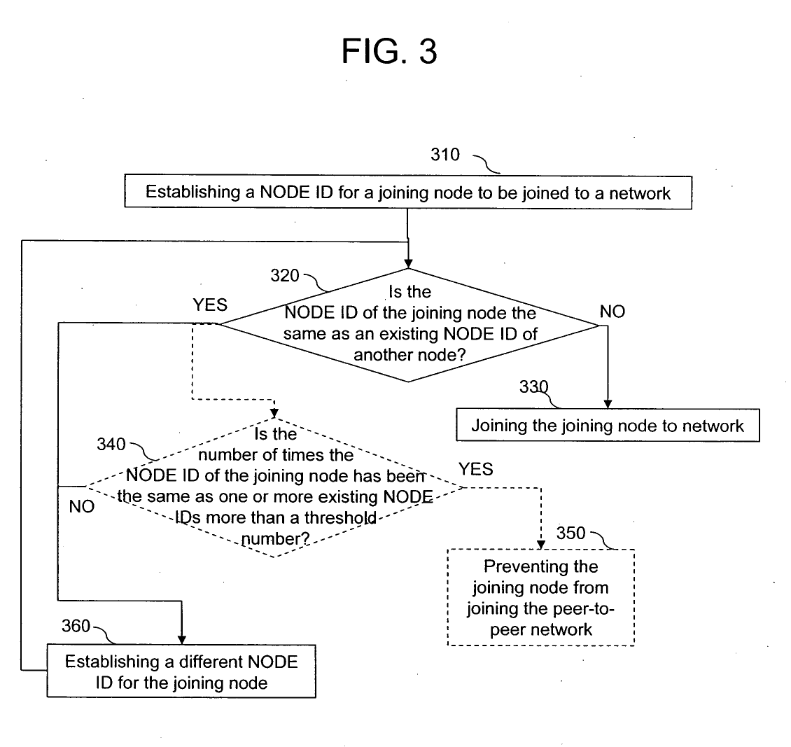

FIG. 3 is a flow chart illustrating a method of collision detection for a node ID in accordance with another exemplary embodiment of the present invention.

Referring now to FIG. 3, at block 310 a joining node to be joined to network 100 (e.g., a peer-to-peer network or some other distributed network) may establish a node ID.

Block 310 determines whether the node ID established at block 210 is the same as an existing node ID on peer-to-peer network 100. The determination may include: sending a message (either a join message or a lookup message) from the joining node to a node having the same node ID as the joining node. Sending either a join message or a lookup message enables checking of whether an error message related to the join message or a successful lookup related to the look message occurs. If the error message related to the join message or a successful lookup occurs, a collision of the joining node ID is indicated. Alternatively, sending a check message to the assignment node responsible for resources with resource IDs closest to the node ID of the joining node enables comparison of the node ID of the joining node with the node IDs (resource IDs) stored in the assignment (responsible) node. In the exemplary embodiment, closest refers to resource IDs that may succeed the assignment node ID.

The routing of the message from the joining node to the assignment node may include one or more intermediate node hops (i.e., communications). That is, since the joining node does not have information (the node ID) of the assignment node, the joining node may send a message (e.g., request), for example, to a bootstrap node (an intermediate node). This message may either be forwarded to the assignment node (either directly or through intermediate nodes) or information regarding the node ID of the assignment node may be sent to the joining node and the joining node may then route the message to the assignment node.

Although a search for the assignment node is described using a bootstrap node, it is contemplated that other searches are possible. For example, a broadcast message may be sent by the joining node requesting a response by the assignment node.

At block 320, if the node ID of the joining node is determined to be different than any existing node IDs on peer-to-peer network 100, join information may be sent to the joining node to enable the joining node to join the peer-to-peer network 100. The join information may be sent, for example, from the assignment node or the bootstrap node to the joining node. That is, if a check message is sent to the assignment node, which determines that the node ID of the joining node is unique to peer-to-peer network 100, the join information may be sent from the assignment node to the joining node. Alternatively, if the assignment node routes a joining message or a lookup message to the colliding node (i.e., to a node ID identical to that of the joining node), but does not receive a response within a timeout period, the assignment node may update its information to note that the colliding node is not active in the network and may send a response to the joining node providing the join information.

The join information may include the predecessor node and successor node of the joining node. At block 330, after receiving the predecessor and successor node information, the joining node may send and receive further messages from successor and predecessor nodes to complete the joining process.

At block 340, the method determines whether the number of error messages or lookup successes indicating node ID collisions is greater than a predetermined threshold number (i.e., an excessive number of node ID collisions are indicated). At block 350, if the number of error messages or lookup successes is greater than the predetermined threshold number, the joining node may be prevented from joining the peer-to-peer network. For example, messages may be rejected that request joining of any node with the same IP address and/or port number as that of the joining node. This rejection may be for an indefinite or a predetermined period of time. In this way, intentional attacks based on node ID collisions may be substantially reduced.

At block 360, the joining node may establish (process) a different node ID responsive to an indication of a node ID collision sent by the assignment node or the colliding node. The processing of the different node ID for the joining node may include generating a new node ID. The processing from block 360 returns to block 320.

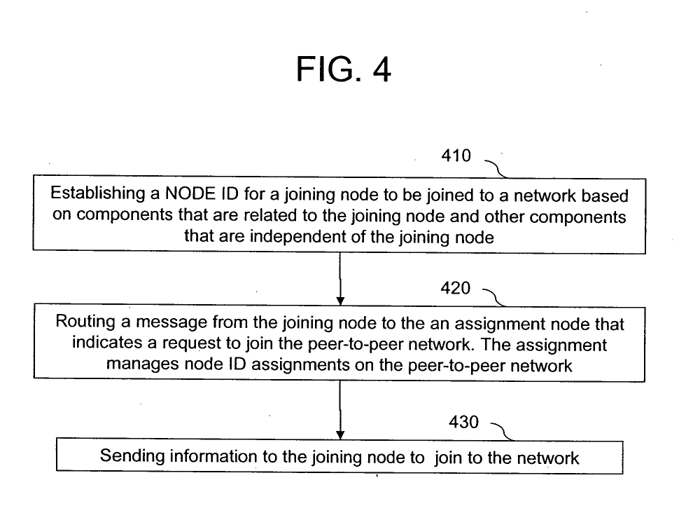

FIG. 4 is a flow chart illustrating a method of collision detection for a node ID in accordance with yet another exemplary embodiment of the present invention.

Referring now to FIG. 4, at block 410 a joining node to be joined to network 100 (e.g., a peer-to-peer network or some other distributed network) may establish a node ID, based on components that are related to the node and other components that are independent of the joining node. For example, the components which are related to the joining node may include an IP address of the joining node and/or a port number and the components which are independent of the joining node may include a random bit stream. The establishment of the node ID may include hashing a value that is a combination of an IP address of the joining node, a port number of the joining node and a random bit stream, and may include concatenating these components or some other algebraic combination of these components for further security of the IP address and the port number of the joining node. The random bit stream may be of sufficient length, based on an overall number of node IDs on the peer-to-peer network, to ensure a unique node ID with a predetermined probability or greater.

At block 420, a message including the node ID of the joining node may be routed to an assignment node that manages resources with resource IDs closest to the node ID of the joining node (e.g., succeeding the resource ID). The routing of the message from the joining node to the assignment node may include one or more intermediate node hops (i.e., communications). That is, since the joining node does not have the assignment node ID, the joining node may send a message (e.g., request), for example, to a bootstrap node (e.g., an intermediate node). This message may either be forward to the assignment node (either directly or through other intermediate nodes) or information regarding the assignment node ID may be sent to the joining node and the joining node may then route the message to the assignment node.

At block 430, the joining information may be sent from the assignment node to the joining node, and may include the predecessor node and successor node of the joining node. After receiving the predecessor and successor nodes, the joining node may send and receive messages from the successor and predecessor nodes to complete the joining process.

According to certain exemplary embodiments, methods for node ID collision detection for P2P networks are provided to reduce and/or eliminate the possibility that node IDs on such networks are identical and, thus, enhance overall system performance of these P2P networks and reduce system errors caused by such collisions.

Although the invention has been described in terms of a P2P network, it is contemplated that it may be implemented in software on microprocessors/general purpose computers. In various embodiments, one or more of the functions of the various components may be implemented in software that controls a general purpose computer. This software may be embodied in a computer readable carrier, for example, a magnetic or optical disk, a memory-card or an audio frequency, radio-frequency, or optical carrier wave.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for joining a network resource, as a joining node, to a peer-to-peer network, comprising the steps of:
a) establishing a node ID for the joining node to be joined to the peer-to-peer network;
b) routing a message to an assignment node that manages resources with resource IDs closest to the node ID of the joining node;
c) determining whether the node ID established in step (a) is identical to one of the node IDs on the peer-to-peer network; and
d) joining the joining node to the peer-to-peer network when the node ID of the joining node is not identical to any one of the node IDs managed by the assignment node.

2. The method according to claim 1, wherein step (c) of determining whether or not the node ID for the joining node is identical to the one of the node IDs on the peer-to-peer network includes
comparing the node IDs managed by the assignment node to the node ID of the joining node, and
sending a join message from the assignment node to the joining node to enable joining of the joining node to the peer-to-peer network when none of the node IDs managed by the assignment node matches the node ID of the joining node.

3. The method according to claim 1, wherein step (c) of determining whether the node ID for the joining node is identical to the one of the node IDs on the peer-to-peer network includes comparing the node IDs managed by the assignment node to the node ID of the joining node, and the method further comprises the step of
e) sending an other message from the assignment node to the joining node indicating a node ID collision when one of the node IDs managed by the assignment node matches the node ID of the joining node.

4. The method according to claim 1, wherein step (c) of determining whether the node ID for the joining node is identical to the one of the node IDs on the peer-to-peer network includes
comparing the node IDs managed by the assignment node to the node ID of the joining node and identifying as a colliding node a node having a node ID managed by the assignment node that matches the node ID of the joining node;
routing the message from the assignment node to the colliding node; and the method further comprising the step of
e) sending an other message to the joining node indicating a node ID collision when the colliding node responds to the message from the assignment node.

5. The method according to claim 4, wherein the message routed to the assignment node is a join message and the other message sent to the joining node is an error message indicating the node ID collision.

6. The method according to claim 4, wherein the message routed to the assignment node is a lookup message and the other message sent to the joining node is a lookup success message indicating that a node with a node ID identical to the node ID of the joining node has been identified.

7. The method according to claim 4, further comprising the step of:
f) responsive to reception of the other message, establishing a node ID for the joining node, which is different from any other node ID previously used to join the joining node to the peer-to-peer network by changing the one or more components of the node ID that are independent of the joining node; and
g) repeating steps (b) through (d) using the different node ID to join the joining node to the peer-to-peer network.

8. The method according to claim 4, further comprising the steps of:
g) determining a number of error messages indicating node ID collisions received by the joining node; and
h) preventing the joining node from joining the peer-to-peer network, when the number of error messages determined in step (g) is more than a predetermined threshold number.

9. A method for joining a network resource as a joining node to a peer-to-peer network, comprising the steps of:
a) establishing a node ID for the joining node to be joined to the peer-to-peer network based on one or more components related to the joining node and one or more components independent of the joining node;
b) routing the join message to a node that manages resources with resource IDs closest to the node ID of the joining node; and
c) joining the joining node to the peer-to-peer network when the node ID of the joining node is not identical to any one of the node IDs managed by the node that manages the resources with the resource IDs closest to the node ID of the joining node.

10. The method according to claim 9, wherein step (a) of the establishing the node ID includes the steps of:
determining an IP address of the joining node; and
using the IP address of the joining node to derive the component related to the joining node.

11. The method according to claim 9, wherein step (a) of the establishing the node ID includes the steps of:
determining a port number of the joining node; and
using the IP address and the port number of the joining node to derive the component related to the joining node.

12. The method according to claim 9, wherein step (a) of the establishing the node ID includes the steps of:
generating a random bit stream; and
using the random bit stream to derive the component independent of the joining node.

13. The method according to claim 12, wherein step (a) of the establishing the node ID includes the steps of:
applying a hash function to a value that is a combination of an IP address of the joining node, a port number of the joining node and the random bit stream to generate the node ID.

14. The method according to claim 12, wherein the step of generating the random bit stream includes
providing the random bit stream having a sufficient length based on an overall number of node IDs on the peer-to-peer network to ensure a unique node ID with a probability of 99% or greater.

15. A method for joining a network resource as a joining node to a peer-to-peer network, comprising the steps of:
a) establishing a node ID for the joining node based on one or more components which are related to the joining node and one or more components which are independent of the joining node;
b) sending a message including the node ID from the joining node to one or more other nodes;
c) routing the join message to an assignment node that manages resources with resource IDs closest to the node ID of the joining node;
d) determining whether or not the node ID established in step (a) is identical to one node ID managed by the assignment node; and
e) joining the joining node to the peer-to-peer network, when the node ID of the joining node is not identical to any of the node IDs managed by the assignment node.

16. The method according to claim 15, wherein the components which are related to the joining node include at least an IP address and a port number of the joining node.

17. The method according to claim 16, wherein the components independent of the joining node include a random bit stream.

18. The method according to claim 17, wherein the node ID of the joining node is a hash value of a concatenation of the IP address of the joining node, the port number of the joining node and the random bit stream.

19. The method according to claim 15, further comprising the step of:
f) sending an other message to the joining node indicating a node ID collision when one of the node IDs managed by the assignment node matches the node ID of the joining node.

20. The method according to claim 19, further comprising the steps of:
g) responsive to reception of the other message by the joining node in step (f), establishing a node ID for the joining node, which is different from other node IDs previously used to join the joining node to the peer-to-peer network by changing the one or more components that are independent of the joining node; and
h) repeating steps (b) through (g) using the different node ID to join the joining node to the peer-to-peer network.

21. The method according to claim 19, wherein:
step (d) of determining whether or not the node ID of the joining node is identical to one of node ID managed by the assignment node includes the step of routing the join message from the assignment node to a colliding node having a node ID that matches the node ID of the joining node, and
step (f) of sending the other message to the joining node indicating the node ID collision includes the step of sending the other message from the colliding node to the joining node indicating the node ID collision.

22. The method according to claim 20, wherein the other message sent to the joining node is one of an error message indicating the node ID collision or a lookup success message indicating that a node with an identical node ID to that of the joining node has been identified.

23. The method according to claim 22, further comprising the steps of:
g) determining a number of the error messages or the lookup success messages indicating node ID collisions that have been received by the joining node; and
h) preventing the joining node from joining the peer-to-peer network, when the number of the error messages or the lookup success messages determined in step (g) is more than a predetermined threshold number.

24. A computer readable medium including software that is configured to control joining of the joining node to the peer-to-peer network by implementing a method according to claim 1.

25. A computer readable medium including software that is configured to control joining of the joining node to the peer-to-peer network by implementing a method according to claim 8.
